(19) United States
(12) Patent Application Publication
(10) Pub. No.: US 2011/0137977 A1
(43) Pub. Date: Jun. 9, 2011

(54) METHOD AND SYSTEM FOR GENERATING RICH CLIENT APPLICATIONS FOR ADMINISTRATORS AND TRANSLATORS

(75) Inventors: Yiftach NUN, Tel Mond (IL); David RACHAMIM, Cfar Hanagid (IL); Inbal ZILBERMAN, Ramat -Gan (IL)

(73) Assignee: SAP AG, Walldorf (DE)

(21) Appl. No.: 12/631,870

(22) Filed: Dec. 7, 2009

(51) Int. Cl. G06F 15/16

(52) U.S. Cl. 709/203

(57) ABSTRACT

9. A method for providing an admin-user with a client User-Interface (UI) for managing a client application, comprising: defining at least one admin-user privilege level; providing a client application with an end-user UI definition and at least one admin-user privilege level definition; providing a run-time application adapted to execute the client application alternatively at an end-user privilege level, and at the at least one admin-user privilege level, wherein the run-time application is adapted to provide a rich client UI when invoked by an admin-user and wherein the run-time application is adapted to modify the end-user UI definition in response to inputs received from an admin-user when invoked with admin-user level privilege.

### TECHNICAL FIELD

The present disclosure relates generally to the field of client-server applications and more particularly to a method and system for enabling an administrator or a translator on the client-end to work in an environment that resembles an end-user environment

### BACKGROUND

In a client-system system there is a common use of applications that provide application to the end-user and a separate ability to the administrators to change the applications and a separate ability to the translators to translate the application. Typically an application is provided at a basic privilege level to the end-user at the client-end and with additional privilege levels to administrators that serve the client-end through the server side.

In a typical scenario the end-user uses the application for example to fill a form for asking/reporting a vacation, to ask for reimbursement of expenses, to send a weekly report to his/her manager etc. For these simple tasks the application provides the end-user with a specific form that can be filled by the end-user. For example, when an end-user wants to ask for a vacation he/she may use the client-server application (for example “DUET” by SAP AG) to open/show the form by a common S/W application such as “OUTLOOK” (Microsoft™). (OUTLOOK is invoked by an add-on tool on the client-end that is attached to “DUET”).

When the “Vacation” form is opened, the end-user may fill the form by entering data fields according to a predefined data structure. For example the end-user may fill his/her first name, given name, his/her worker I.D. user I.D., the year month and days at which he/she wants to get a vacation, his/her manager's name etc. Typically, the end-user has no option to edit the form apart from filling data entries.

However, from time to time a need arises to make changes in the forms, to add an additional field to the form (e.g. to add “current project name” where the employee is asked to provide the name of the project that he is working on at the time of submitting the form). These types of updating the end-user UI usually take place at the period when the application is already in use.

Another type of modifications of the end-user UI is a translation task, which typically (but not always) takes place at the development phase, when a form is completed in one language and is handed to a translator in order to translate the form (or generally to translate the application UI) to one or more languages. Sometimes translation can be done also at a later point in time, For example the company wishes to translate the title of the form from “Vacation” to “URLAUB” (German word for vacation). Evidently, this should not be done by an end-user. Such modifications require a higher degree of authorization/privilege level which is typically saved for administrators. Typically, such changes are global, i.e. they will affect the user-interface (UI) of all the end-users that will invoke the application at a later point in time, or at least they will affect the UI that is provided to an entire group of end-users (e.g. all German speakers or users that have selected German as the UI language).

In accordance with the prior art, when an administrator (hereinafter—“admin-user” which in the present disclosure includes also a translator, although these are different types of task) wants to modify a form, he/she would have to edit fields in a configuration environment which typically is built in an hierarchical structure, according to a logical view, according to the configuration topic, and usually, does not resemble the UI as the user experiences it (an example is shown in FIG. 2B).

The main disadvantage of such an approach is that the admin-user is not aware of the context of the end-user and cannot see exactly how the configurations done by him/her are affecting the end-user. This approach can cause mistakes, unnecessary translation cycles and misunderstandings that originate from the lack to foresee the end result of the configuration/translation It should be noted that in big entities/organizations there may be many administrators, some of them may be external consultants, less familiar with the organization forms and terms, which turns this process of modifying forms to be more prone to mistakes. In the same way, a Translator which needs to translate new terms on the client UI would usually get a list of words or lines to translate without any understanding of the context and the result of the translation as mentioned above.

Thus, there is a need for a method and system that enables an admin-user a more intuitive environment which has more resemblance to the environment which is experienced by the end-user.

### SUMMARY

An aspect of the disclosed subject matter relates to a method and a system for providing an admin-user with rich client UI that resembles an end-user UI.

In an exemplary embodiment of the disclosed subject matter a client-application UI is defined for an end-user, and a for at least one admin-user privilege level, a run-time application is provided for executing the client application, wherein the run-time application is adapted to provide an admin-user with a rich client UI when invoked by an admin-user, and is adapted to modify the end-user UI definition in response to inputs received from the admin-user.

In an exemplary embodiment of the disclosed subject matter there is provided a method for providing an admin-user with a client User-Interface (UT) for managing a client application, comprising: defining at least one admin-user privilege level; providing a client application with an end-user UI definition and at least one admin-user privilege level definition; providing a run-time application adapted to execute said client application alternatively at an end-user privilege level, and at the at least one admin-user privilege level, wherein the run-time application is adapted to provide a rich client UI when invoked by an admin-user and wherein the run-time application is adapted to modify the end-user UT definition in response to inputs received from an admin-user when invoked with admin-user level privilege;

In an exemplary embodiment of the subject matter the client application is a form.

In an exemplary embodiment of the subject matter the modifications of the end-user UI are saved by the client-server system and when invoking the client application by the end-user after the modifications in the client application were saved by the client-server system—the client application will reflect said modifications.

In an exemplary embodiment of the subject matter the admin-user functionality is translator functionality.

In an exemplary embodiment of the subject matter the runtime application is executed at an admin-user privilege level for translating the end-user client UI.

In an exemplary embodiment of the subject matter, at run-time, the client application is executed by the run-time application with an admin-user privilege definition by an admin-user to provide the admin-user with a rich client UI that has the same appearance as the UT that is seen by the end-user

In an exemplary embodiment of the subject matter there is provided a system for providing an admin-user with a rich UI for managing a client application, comprising: a component for receiving, a client application and a definition of end-user UI and a definition of at least one admin-user privilege level; a component for executing the client application with admin-user privilege level, adapted to modify the definition of the end-user UI and saving the modification in the system; and a component for executing the client application with end-user UI definition wherein said client application UI definition is responsive to said modifications of the definition of the end-user UI.

In an exemplary embodiment of the subject matter there is provided a computer readable storage medium containing a set of instructions for general purpose computer, the set of instructions comprising: a component for receiving a client application and a definition of end-user UI and a definition of at least one admin-user privilege level UI; a component for executing the client application with admin-user privilege level, adapted to enable modifications of the definition of the end-user UI and saving said modifications in the system; and a component for executing the client application with end-user privilege level, wherein said client application UI is responsive to said modifications of the definition of the end-user UI.

### BRIEF DESCRIPTION OF THE DRAWINGS

The present disclosure will be understood and appreciated more fully from the following detailed description taken in conjunction with the drawings. Identical structures, elements or parts, which appear in more than one figure, are generally labeled with a same or similar number in all the figures in which they appear, wherein:

FIG. 1A is a schematic general block diagram of a client-server system having an end-user and an admin-user (prior art):

FIG. 1B is a schematic general block diagram of a client-server system with client enhancement in accordance with the disclosed subject matter.

FIG. 2A is schematic view of an exemplary form that is provided to an end-user (prior art).

FIG. 2B is schematic view of a conventional User Interface (UI) that is provided to an admin-user when modifications of a form are required (prior art)

FIG. 3 is schematic view of a file that is provided to an admin-user when modifications of a form are required in accordance with the disclosed subject matter.

FIG. 4 is a block diagram showing the modules and processes that enable to provide an admin-user with a rich client UI in accordance with the disclosed subject matter.

FIG. 5 is a block diagram showing the modules and processes that provides an improved translation UI in accordance with the disclosed subject matter

FIG. 6 is a block diagram showing the steps of a method for providing an admin-user with a rich client UI, in accordance with the disclosed subject matter.

FIG. 7 is a block diagram describing the components of a system that provides an admin-user with a rich client UI, in accordance with the disclosed subject flatter.

### DETAILED DESCRIPTION

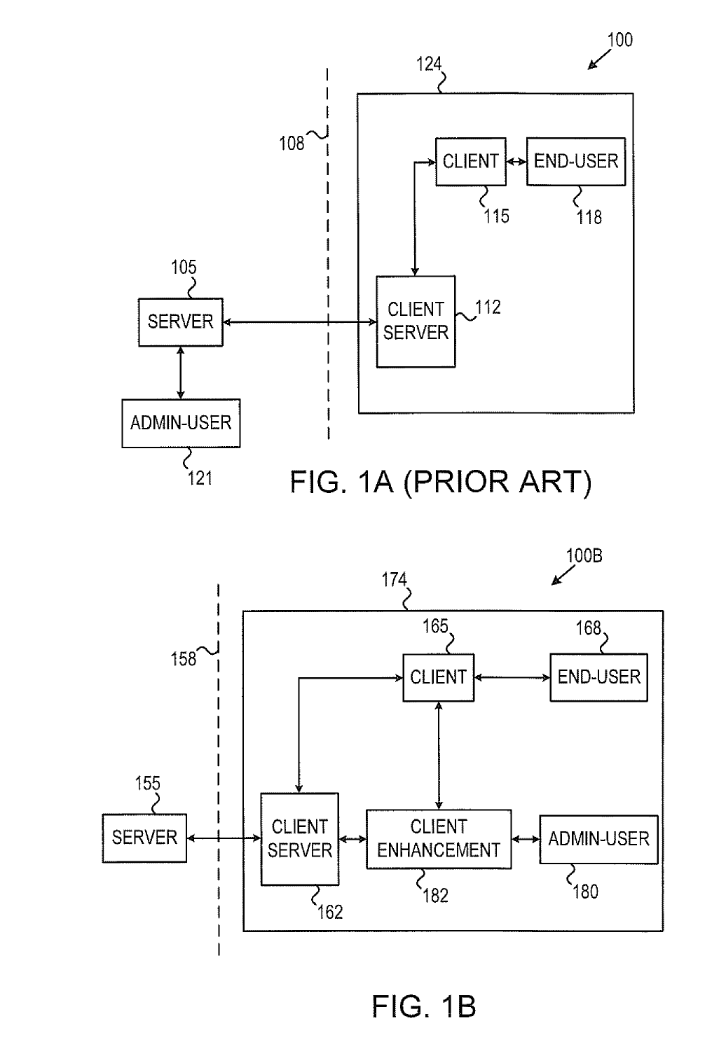

FIG. 1A shows a schematic general block diagram of a client-server system 100 having an end-user. A typical client-server comprises a server 105 and a client 124. The client may include a client-server 112 that is connected between the server 105 and a client 115. The client 115 can be operated by end-users 118. It should be noted that FIG. 1 shows a specific embodiment of the client-server concept, while there may exist numerous alternative embodiments, for example including plurality of servers, plurality of client-servers etc, and the client-server 112 may be omitted etc.

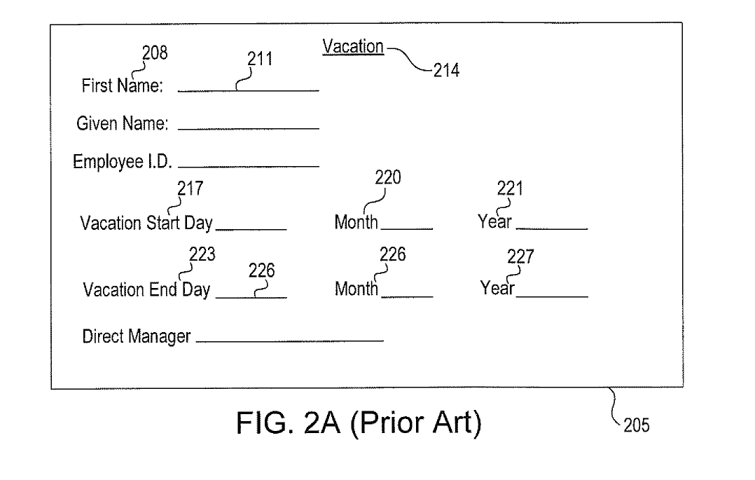

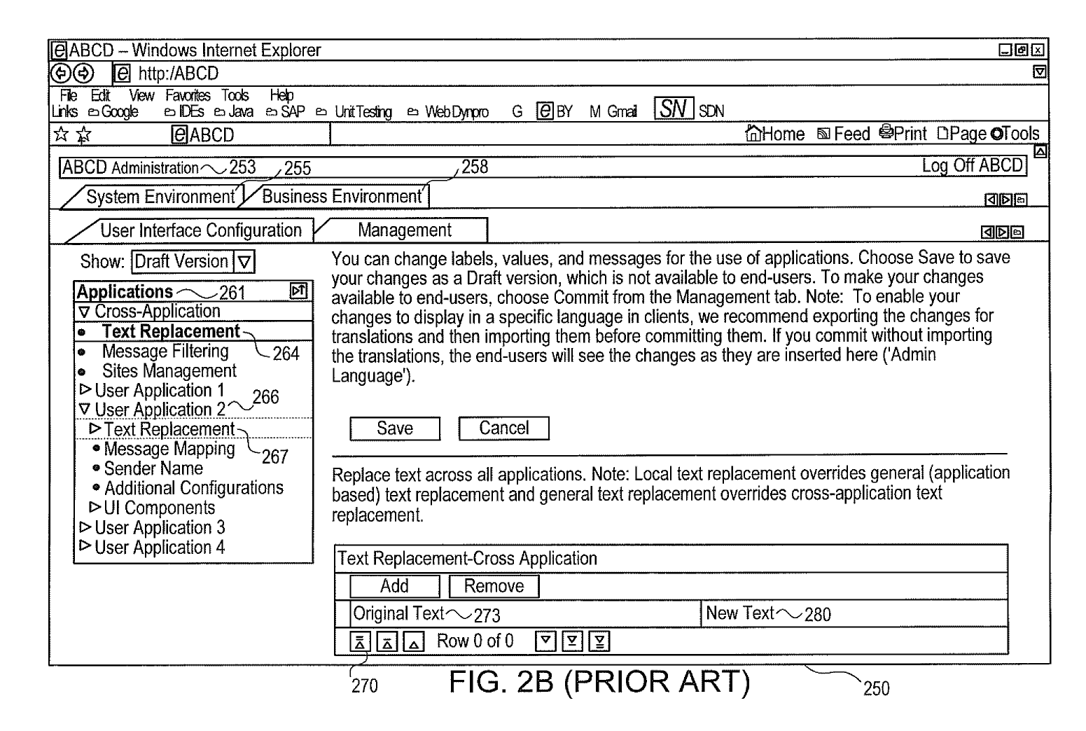

FIG. 2A is schematic view of an exemplary (simplified) form that is provided to an end-user in accordance with the prior art. While the client-server system may serve numerous applications and tasks, the present disclosure relates to applications that provide an end-user with a rich client UI. FIG. 2A shows an example of a “vacation” form 205 that is opened by the application when an end-user, typically an employee, wants to apply for a vacation. FIG. 2A shows a view of an exemplary form that includes a title “vacation” 214 and some rows of data lines including “first name” 208, “given name”, “employee I.D.”, “Vacation start” 217, “Vacation end” 223 and “direct manager”.

FIG. 2A further shows the places where end-user's data inputs are expected—marked by a blank underline. For example—“first name” data input should be entered at blank underline 211. As can be seen in FIG. 2A, the end-user is not able to modify any field/data entry other than those blank fields that are marked with an underline. While FIG. 2A shows an example of a form that is opened by an application that interacts with the end-user and expect him to fill all the blank fields, a person skilled in the art can readily understand that in another example of a form application some of the fields may be filled with default values by the application, for example: first name, given name, employee I.D. and direct manager's name may be filled by the application as they are known and determined by the end-user login details.

FIG. 2B is schematic view of a screen-shot that is provided to an admin-user when modifications of a form are required according to the Prior Art. As shown in FIG. 2B, the admin-user does not see the same view as the end-user sees. The admin-user opens a web-like page 250 that has a title “ABCD Administration” 253 The admin-user selects “system Environment” 255 and scrolls in the hierarchical menus 261 (Applications). 264 (Text Replacement”), 267 (again “Text Replacement”) where he sees the Original Text 270,273 and he may replace it with text that could be entered in the “New text” section 280. It should be noted that an admin-user may also open/run the application as an end-user and have the same UI as an end-user, but when doing so he will not have the ability to modify the application UI as an admin-user.

It could be easily understood that when an admin-user is modifying a form that has substantially a different appearance from the form that is seen by an end-user (view that is possible to get by selection of “Business Environment” 258), the process of modifying forms involves a significant probability of inserting mistakes. For example an admin-user that wants to remove the “Year” from the “Vacation End Day” (assuming that a given “year” for “Vacation Start Day” turns the “year” in “Vacation End Day” redundant), may inadvertently delete the wrong “Year” 221 instead of 227 (FIG. 2A).

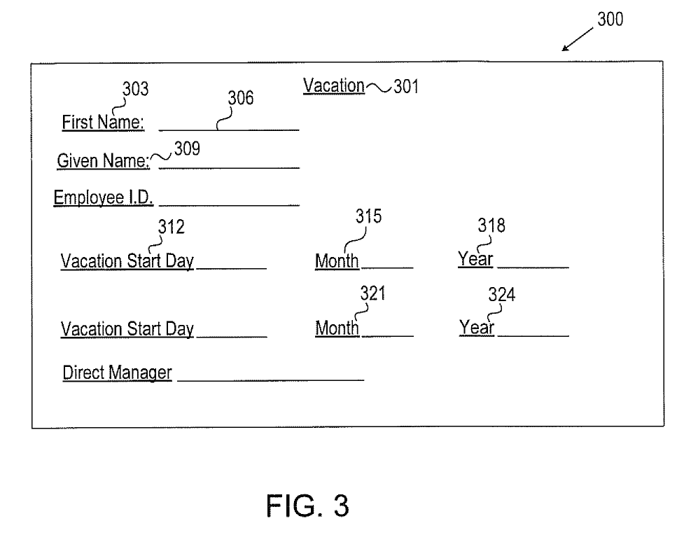

FIG. 3 is schematic view of a screen-shot that is provided to an admin-user when modifications of a form are required in accordance with the disclosed subject matter. FIG. 3 shows a form that has basically the same appearance as the form that is seen by the end-user (FIG. 2A), However, the text appears now in an underlined format 309,312)—to indicate that the underlined fields/text may be modified by the admin-user. It is readily understood that the probability of inserting mistakes by an admin-user, when a format as shown in FIG. 3 is used, is significantly reduced compared to the usage of a UI such as shown in FIG. 2B. In the same way a translator is expected to do fewer mistakes on translating new configured values.

It should he noted that the term admin-user refers to the user's privilege level, thus the admin-user may be an administrator, a translator or any user of the system who has a higher privilege level than the regular end-user and who is authorized to modify the client-application (including its UI). While the process and task of translation usually takes place at the phase of designing and creating the application and the process and task of amending an end-user UI by an administrator usually takes place at a later point in time when the application is already in use by end-users, the present disclosure is applicable to both processes and tasks.

FIG. 1B is a schematic general block diagram of a client-server system 100B with client enhancement in accordance with the disclosed subject matter. FIG. 1B shows that while a regular end-user 168 operates client 165 with a rich UI (FIG. 2A) an admin-user 180 operates client-enhancement/extension 182 that provides him with a rich UI. While the regular end-user 168 has limited editing capabilities (complete the blank fields in a form as shown in FIG. 2A) admin-user is allowed to modify the UI (as shown in FIG. 3). Both admin-user and regular user see the UI in similar appearance—this embodiment reduces the probability of errors/mistakes insertions by admin-user 180.

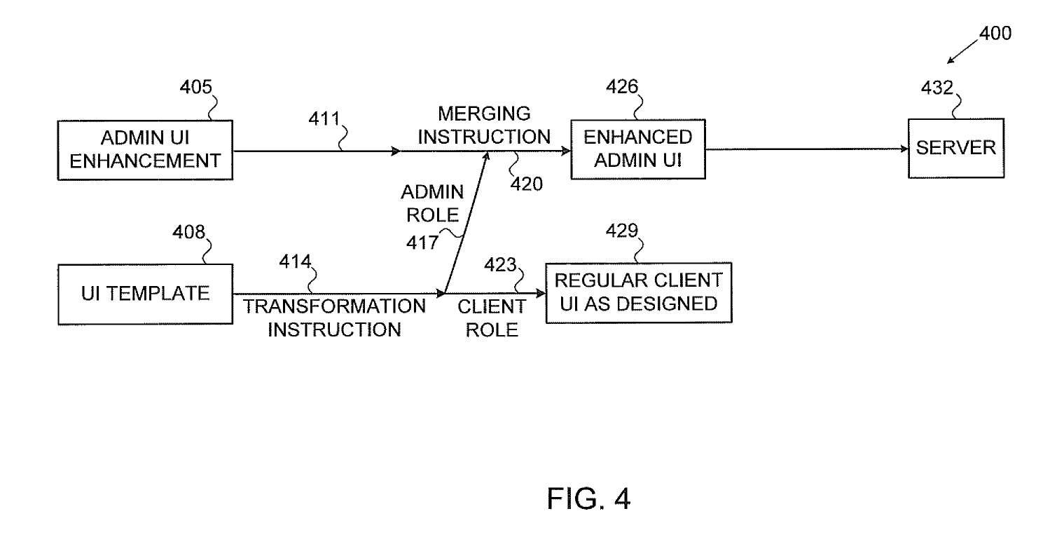

FIG. 4 is a block diagram showing the modules and processes that enable to provide an admin-user with a rich client UI in accordance with the disclosed subject matter. A UI template 408 is generated (e.g. by using a standard XML language). Admin UI enhancement 405 is prepared for the admin-user only. Applying a transformation instruction 414 for an end-user (Client Role) 423 renders a regular client UI 429. Applying a transformation instruction 414 for an admin-user (Admin-Role) 417 merges 420 UI template 408 with UI enhancement 405 to render an enhanced admin UI 426. Modifications that were done by an admin-user while using the enhanced admin UI 426 are communicated to the server 432.

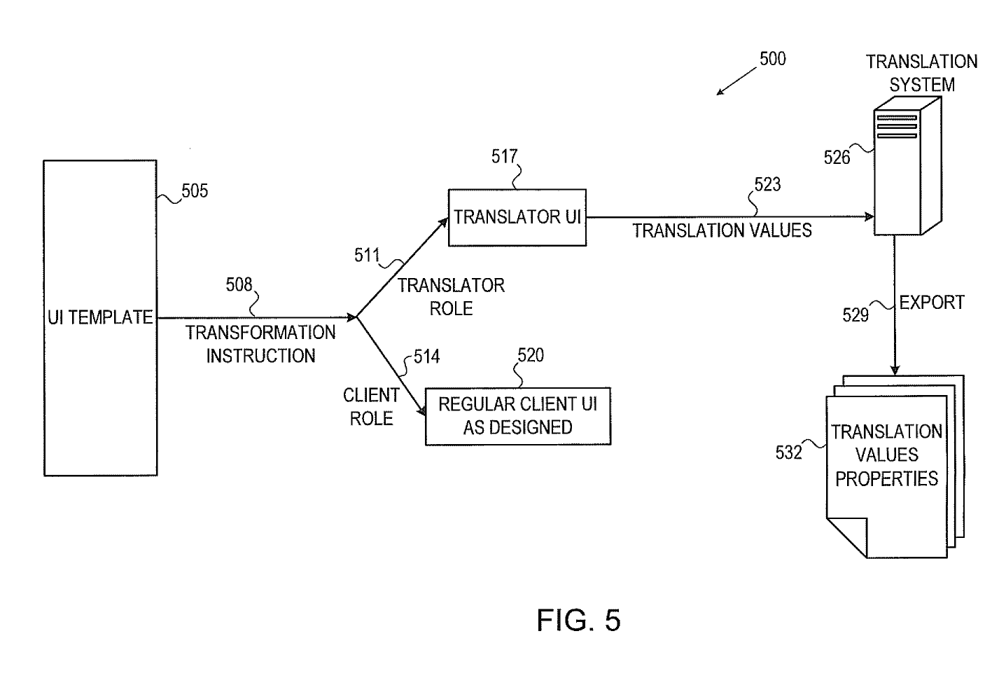

FIG. 5 is a block diagram showing the modules and processes that provide an improved translation UI in accordance with the disclosed subject matter. A translation task is a common task when dealing with forms of international entities. Typically a form that was created in a first language needs to be translated to one or more additional natural languages. In order to guarantee a correct translation the translator must be aware of the context of the text. The advantage of using a translation system is that it contains specific features that assist the translators in their work, such as record of previously translated words/sentences that can be re-used. The result of this process is a bunch of resource files in many languages, which are combined back to the original code base of the product and then released to the customer. The translation program is detached from the context of the user's UI and there is a high probability that the translator may not be aware of the accurate context of the text that is being translated, resulting with an erroneous or not accurate translation. According to the disclosed subject matter, UI template 505, after undergoing a transformation instruction 508, the form/application may render a regular end-user (client) UI 520 if invoked by an end-user (client) role 514. However for translation task the form/application is invoked by a translator role 511 to render a translator UI 517. This process typically takes place after the initial development of the form, but before the form is released to the customer. The generated translation UI (517) is created for the translators. The translators are translating the strings of the UI within their original context. There is still use of the original (or similar) translation system (526), which is responsible for saving the strings that were created by the translators through the translation process, and the generation of the translated resource files. This is done in order to maintain compatibility with existing processes. The process of the translation results in the creation of resources files in all the relevant languages (532). These files are then combined into the original product (in a similar way that is used in prior art) and then released as part of the product. Once the product is released to the customer, the regular user's flow (514, 520) that was described in the beginning of this paragraph, takes place.

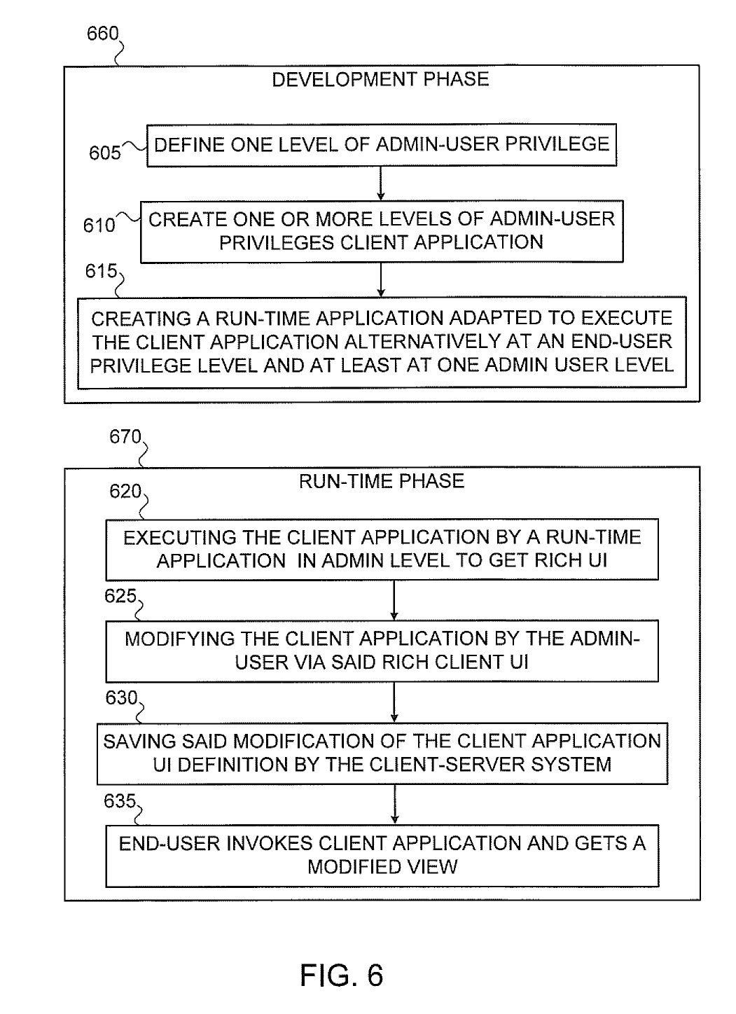

FIG. 6 is a flowchart diagram showing the steps of a method for providing an admin-user with a rich client UI, in accordance with the disclosed subject matter. With reference to FIG. 6, there are two phases of implementing the disclosed subject matter—the first phase is a developing phase 660 where the application is built and the second phase is run-time phase 670, when a form (and in general any application) is opened to modification, saved and updates a server at a first step the developer has to define at least one level of admin-user privilege level (605), it should be noted that it is possible and practical to have multiple levels of admin-user privileges, for example an admin-user that is qualified to modify only restricted list of fields of a form or an admin-user that is qualified to design or re-design a form completely. At the next step the developer creates a client application template (for example a “Vacation” form written in an XML format) that is adapted to be opened in at least one admin-user privilege level (610). Creating a run-time application that is adapted to execute alternatively the form in at least two levels of privileges—i.e. end-user level and at least one admin-user privilege level (615). Obviously steps 610 and 615 can be performed at any order and there is no constraint that requires that step 610 will be done before step 615.

At Run-time phase, admin-user opens/executes a form (or generally any application) wherein the form is opened/executed at an admin-user privilege level (620) i.e. the admin-user sees the same form/screen as an end-user sees, apart from some additional icons or marking which enable the admin-user to edit fields which are Read-Only fields for the end-user (hereinafter “extra fields”). It should be noted that the term “the same form/screen” should be construed as having basically the same appearance and not necessarily exactly the same UI.

Modifying the client application UI by the admin-user via said rich client UT—the admin-user modifies any of the extra fields and saves the changes (625). The run-time application is adapted to modify the end-user UT definition in response to inputs received from an admin-user when invoked with admin-user level privilege. It should be noted that the admin-user may be any kind of user that is authorized to modify the application in a way that will affect the client application (including but not limited to the client application UI) when it will later be invoked by other users, for example, a translator who translates the client application UI from one language to another. Upon saving the changes the modifications are communicated to the server. (It should be noted that as mentioned before, there may be a plurality of servers and configurations of a client-server system and while the current disclosure is not limited to a specific configuration, it does not refer to the server's location or to the client=system configuration but only to the server's functionality). The server processes the changes/modifications and modifies the form/application accordingly (630). When at later point in time an end-user opens the modified form (or in general, operates the modified application), the form/application will reflect the changes that were previously done by the admin-user (635).

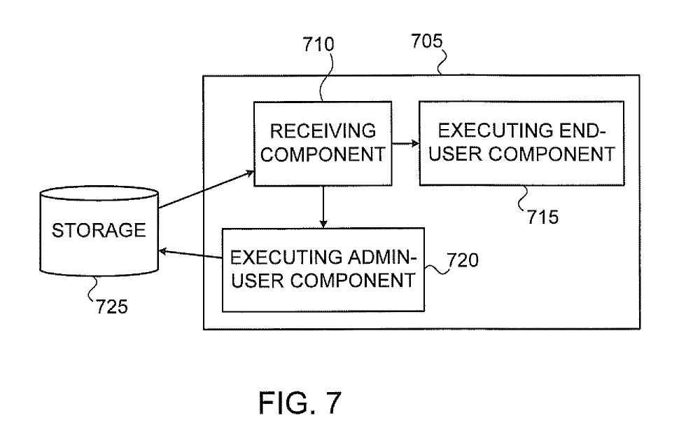

FIG. 7 is a block diagram describing the components of a system that provides an admin-user with a rich client UI, in accordance with the disclosed subject matter FIG. 7 shows a system 705 comprising three components: (a) a component for receiving a client application, (for example, an application that opens a “Vacation” form), and a definition of end-user UI (for example defining the fields of the “Vacation” form and defines the Read-Only fields—such as 208,217 223 etc. in FIG. 2A), and a definition of at least one admin-user privilege level 710 (for example the definition of 303,309, 312 in FIG. 3 as writable fields);

(b) a component for executing the client application with admin-user privilege level, adapted to enable modifications of the definition of the end-user UI (e.g. enabling the modification of the title “Vacation” to “Urlaub”) and saving said modification in the system 705 or at a storage 725;

(c) a component for executing the client application with end-user UI definition 715, wherein the client application UI definition is responsive to said modifications of the definition of the end-user UI. (E.g. if the title “Vacation” was modified by component b to be “Urlaub”—executing the client application by an end-user will show the updated title “Urlaub”).

It should be appreciated that the above described methods and systems may be varied in many ways, including omitting or adding steps, changing the order of steps and the type of devices used. It should be appreciated that different features may be combined in different ways. In particular, not all the features shown above in a particular embodiment are necessary in every embodiment of the disclosed subject matter. Further combinations of the above features are also considered to be within the scope of some embodiments of the disclosed subject matter.

Section headings are provided for assistance in navigation and should not be considered as necessarily limiting the contents of the section.

It will be appreciated by persons skilled in the art that the present disclosure is not limited to what has been particularly shown and described hereinabove. Rather the scope of the present disclosure is defined only by the claims, which follow.

1. In a client-server system, a method for providing an admin user with a client User-Interface (UI) for managing a client application, the method comprising:
(a) defining at least one admin-user privilege level;
(b) providing a client application with an end-user UI definition and at least one admin-user privilege level definition;
(c) providing a run-time application adapted to execute said client application alternatively at an end-user privilege level, and at the at least one admin-user privilege level, wherein the run-time application is adapted to provide a rich client UI when invoked by an admin-user and wherein the run-time application is adapted to modify the end-user UI definition in response to inputs received from an admin-user when invoked with admin-user level privilege;

2. The method according to claim 1 wherein said client application is a form.

3. The method according to claim 1 wherein said modifications of the end-user UI are saved by the client-server system and when invoking said client application by said end-user after the modifications in the client application were saved by the client-server system—the client application will reflect said modifications.

4. The method according to claim 1 wherein the admin-user functionality is translator functionality.

5. The method according to claim 1 wherein the runtime application is executed at an admin-user privilege level for translating the end-user client UI.

6. The method according to claim 1 wherein at run-time, said client application is executed by said run-time application with an admin-user privilege definition by an admin-user to provide said admin-user with a rich client UI that has the same appearance as the UI that is seen by the end-user

7. A system for providing an admin-user with a rich UI for managing a client application, comprising:
(a) a component for receiving a client application and a definition of end-user UI and a definition of at least one admin-user privilege level;
(b) a component for executing the client application with admin-user privilege level, adapted to modify the definition of the end-user UI and saving said modification in the system; and
(c) a component for executing the client application with end-user UI definition wherein said client application UI definition is responsive to said modifications of the definition of the end-user UI.

8. A computer readable storage medium containing a set of instructions for general purpose computer, the set of instructions comprising:
(a) a component for receiving a client application and a definition of end-user UI and a definition of at least one admin-user privilege level UI;
(b) a component for executing the client application with admin-user privilege level, adapted to enable modifications of the definition of the end-user UI and saving said modifications in the system; and
(c) a component for executing the client application with end-user privilege level, wherein said client application UI is responsive to said modifications of the definition of the end-user UI.
